(19) United States
(12) Patent Application Publication
(10) Pub. No.: US 2013/0057438 A1
(43) Pub. Date: Mar. 7, 2013

(54) ANTENNA DEVICE AND PORTABLE WIRELESS TERMINAL EQUIPPED WITH THE SAME

(71) Applicants: Hiroshi Satou, Kanagawa (JP); Yoshio Koyanagi, Kanagawa (JP); Takanori Hirobe, Ishikawa (JP)

(72) Inventors: Hiroshi Satou, Kanagawa (JP); Yoshio Koyanagi, Kanagawa (JP); Takanori Hirobe, Ishikawa (JP)

(73) Assignee: PANASONIC CORPORATION, Osaka (JP)

(21) Appl. No.: 13/696,951

(22) PCT Filed: May 12, 2011
(86) PCT No.: PCT/JP2011/002656

§ 371 Date: Nov. 8, 2012

(30) Foreign Application Priority Data
May 13, 2010 (JP) 2010-110742

(51) Int. Cl. H01Q 21/00

(52) U.S. Cl. 343/702; 343/893; 343/843; 343/853

(57) ABSTRACT

The connection circuit 108 reduces degradation in the coupling between the antenna elements by performing adjustment to cancel the mutual coupling between the first antenna element 106 and the second antenna element 107 in a first frequency band. Concurrently, the length 110 of the short side of the first antenna element and the length 109 of the short side of the second antenna element are set to predetermined lengths which are different, thereby reducing the amounts of current which does not contribute to radiation. With such a configuration, it is possible to achieve high-efficiency loosely coupled MIMO array antennas operating in the same frequency in a portable wireless terminal.

### TECHNICAL FIELD

The present invention relates to an antenna device and a portable wireless terminal equipped with the same. In particular, the present invention relates to an array antenna for a portable terminal, and which reduces degradation in coupling between elements such that both of the two elements have high antenna efficiencies.

### BACKGROUND ART

Portable wireless terminals such as mobile phones have been developed to have more and more functions for example, not only the telephone function, the electronic mail function, and the function of access to the Internet; but also the near-field wireless communication function, the wireless LAN function, the GPS function, the TV-viewing function, the IC card transaction function, and the like. In addition, in cellular communications, as a technique for achieving a high-speed and high-capacity wireless communication system, it can be expected to provide spatial multiplexing transfer (MIMO: Multi-Input Multi-Output) for performing communication by using a plurality of antennas on the transmission side and the reception side. In this technique, the spatial multiplexing is performed by transmitting the same signals which are space-time coded from a plurality of transmission antennas in the same band, and information is extracted by receiving and separating the signals through a plurality of reception antennas. Thereby, the transfer speed is improved, and thus it becomes possible to perform high-capacity communication. As the number of functions thereof increases, the number of antennas mounted in the portable wireless terminal tends to increase. Thus, there is a serious problem in that degradation in the antenna performance, particularly, deterioration in antenna efficiency is caused by coupling between the plurality of antenna elements.

On the other hand, from the viewpoint of design and mobility, it is desired that the portable wireless terminal has a small size and is highly integrated. In order to maintain favorable antenna characteristics while achieving reduction in the size of the device, various studies for maintaining high antenna efficiency are necessary for the arrangement of the antenna elements and coupling between the antenna elements. Further, a high-performance antenna system, which is subject to the coupling degradation countermeasures by reducing the number of power supply paths and the number of antenna elements as much as possible and maintains high antenna efficiency, is required.

As the existing portable wireless device coping with the problem of the coupling between the antenna elements, for example, as disclosed in PTL 1 and NPL 1, there is a known configuration for achieving high antenna efficiency through weak coupling which is made between the feeding points of the antennas by connecting the power supply sections of the array antenna elements through a connection circuit inserted therebetween so as to cancel the phase between the feeding points of the antennas.

Further, as disclosed in PTL 2, by changing the shapes of the load patterns disposed on the leading end portions of the antenna elements, even when the antenna elements are close, the antenna element shape capable of obtaining favorable impedance matching is provided.

### CITATION LIST

### Patent Literature

[PTL 1] US Unexamined Patent Application Publication No. 2008/0258991

[PTL 2] JP-A-2003-023317

### Non Patent Literature

[NPL 1] “Decoupling and descattering networks for antennas”, IEEE Transactions on Antennas and Propagation, vol. 24 Issue 6, Nov. 1976

### SUMMARY OF INVENTION

### Technical Problem

In existing configurations disclosed in NPL 1 and PTL 1, for example, as shown in FIG. 6A of PTL 1, by inserting the connection circuit so as to connect the power supply sections of the array antenna elements, weak coupling can be made between the feeding points of the antennas. Since the electric power supplied from a certain feeding point is input to a different feeding point such that the electric power consumed in the resistance component of the characteristic impedance is reduced, the antenna efficiency is improved. However, since the electric power consumed by the characteristic impedance at the different feeding point is reduced by inserting the connection circuit, the current staying in the elements is present for a long period of time, and the electric power exchanged between the elements, that is, a sort of resonance phenomenon occurs between both elements. As a result, the antenna efficiency is reduced by conductor loss caused by the exchange of the electric power. That is, in the countermeasures of the weak coupling made by inserting the connection circuit, by reducing the electric power consumed in the resistance component of the characteristic impedance of the power supply section which does not supply electric power, it is possible to improve the antenna efficiency to a certain extent. However, there is a trouble that the conductor loss caused by the electric power exchanged between the elements increases, and thus a problem arises in that the antenna efficiency is not surely maximized.

Further, as disclosed in PTL 2, by changing the shapes of the load patterns disposed on the leading end portions of the antenna elements, even when the antenna elements are close, the antenna element shape capable of obtaining favorable impedance matching is provided. However, there is a problem in that means for improving the coupling between the antenna elements is not provided and degradation in the coupling between the elements cannot be surely ameliorated by matching impedances of the elements.

### Solution to Problem

In the present invention, in the portable wireless terminal on which two substantially rectangular antenna elements disposed in parallel in order to be compliant with MIMO and the like are mounted in an array, in order to solve the above-mentioned problem, a configuration is made such that the lengths of the short sides of the antenna elements are set to be different, that is, the widths of the elements are set to have a predetermined proportion.

In the above-mentioned condition, when weak coupling between the power supply sections is further made, power loss in the power supply section opposed to the power supply section, which supplies electric power, is reduced. Furthermore, it is possible to reduce loss of the electric power exchanged between elements, and it is possible to further improve the antenna efficiency. Hence, it is desirable to provide an array antenna device, which is capable of achieving ever-higher antenna efficiency at an arbitrary frequency, and a portable wireless terminal equipped with the same.

The antenna device of the present invention includes a circuit board; a first antenna element that is made of a conductive metal and is substantially rectangular; a second antenna element that is made of a conductive metal and is substantially rectangular; and a connection circuit that electrically interconnects the first antenna element and the second antenna element. The first antenna element and the second antenna element are electrically connected to a first power supply section and a second power supply section which are disposed in parallel with each other on the end of the circuit board. A length of a short side of the first antenna element and a length of a short side of the second antenna element are adjusted to have a difference which does not cause resonance phenomenon in electric power between the first antenna element and the second antenna element.

With such a configuration, the first power supply section and the second power supply section are loosely coupled. Thus, it is possible to reduce the loss of power leaking from the power supply sections to each other, and it is possible to reduce conductor loss caused by the electric power exchanged between the elements due to the resonance phenomenon of the electric power generated between the first antenna element and the second antenna element. As a result, it is possible to achieve an array antenna capable of achieving ever-higher antenna efficiency in an arbitrary frequency.

The antenna device of the present invention includes: a casing; a circuit board that is provided in the casing and has a ground pattern; a first antenna element that is made of a conductive metal and is substantially rectangular; a second antenna element that is made of a conductive metal and is substantially rectangular; and a connection circuit that electrically interconnects the first antenna element and the second antenna element. The first antenna element and the second antenna element are disposed to be close to each other substantially in parallel at a predetermined distance away from the ground pattern on the circuit board, and are electrically connected to the first power supply section and the second power supply section which are disposed on the ends of the circuit board. The length of the short side of the first antenna element and the length of the short side of the second antenna element satisfy that (|the length of the short side of the first antenna element−the length of the short side of the second antenna element|)+(the length of the short side of the first antenna element+the length of the short side of the second antenna element) is less than or equal to approximately 0.1 and is greater than 0. The connection circuit is adjusted such that mutual coupling between the first antenna element and the second antenna element in a first frequency band is canceled.

With such a configuration, the first power supply section and the second power supply section are loosely coupled. Thus, it is possible to reduce the loss of power leaking from the power supply sections to each other, and it is possible to reduce conductor loss caused by the electric power exchanged between the elements due to the resonance phenomenon of the electric power generated between the first antenna element and the second antenna element. As a result, it is possible to achieve an array antenna capable of achieving ever-higher antenna efficiency in an arbitrary frequency.

Further, in the antenna device of the present invention and the portable wireless terminal equipped with the same, the distance between the closest sides of the first antenna element and the second antenna element is less than or equal to 0.5 wavelengths in the first frequency band.

With such a configuration, even in a state where the antennas are extremely close, it is possible to achieve high antenna efficiency with a low conductor loss. Thus, it is possible to design a small-size array antenna.

Furthermore, in the antenna device of the present invention and the portable wireless terminal equipped with the same, a length of each long side of the first antenna element and the second antenna element is less than or equal to 0.5 wavelengths in the first frequency band.

With such a configuration, even when the lengths of the antenna elements are short, it is possible to achieve high antenna efficiency with a low conductor loss. Thus, it is possible to design a small-size array antenna.

Moreover, in the antenna device of the present invention and the portable wireless terminal equipped with the same, the first antenna element is electrically connected to the first power supply section through a first impedance matching circuit, and the second antenna element is electrically connected to the second power supply section through a second impedance matching circuit.

With such a configuration, in the desired frequency band, it is possible to match impedances of the antennas in combination with weak coupling. Hence, it is possible to achieve the antenna characteristics with low conductor loss and high antenna efficiency through further weak coupling.

Further, in the antenna device of the present invention and the portable wireless terminal equipped with the same, the first antenna element and the second antenna element are disposed to be substantially orthogonal to a principal surface of the circuit board on a side of the circuit board, are bent along an inner wall of the casing, and are disposed in the casing.

With such a configuration, the antenna elements can be disposed even in a small occupied volume within the terminal, and thus it is possible to achieve a small-size array antenna.

Furthermore, in the antenna device of the present invention and the portable wireless terminal equipped with the same, either one or both of the first antenna element and the second antenna element is formed as a copper foil pattern on a printed-circuit board.

With such a configuration, the antenna elements can be disposed with high accuracy, and thus it is possible to achieve an array antenna that is advantageous in mass production.

Moreover, the antenna device of the present invention is mounted on a MIMO-capable portable wireless terminal.

With such a configuration, it is possible to improve the antenna characteristics of the MIMO-capable portable wireless terminal, and thus it is possible to reduce the size of the portable wireless terminal.

### Advantageous Effects of Invention

According to the antenna device of the present invention and the portable wireless terminal equipped with the same, it is possible to achieve a loosely coupled, low-conductor-loss, high-antenna-efficiency MIMO array antenna which operates at the same frequency.

### BRIEF DESCRIPTION OF DRAWINGS

FIG. 1 is a configuration diagram of a portable wireless terminal according to Embodiment 1 of the present invention.

FIG. 2(a) is a conceptual diagram of power transfer between the power supply sections in a case where a length 110 of the short side of a first antenna element and a length 109 of the short side of a second antenna element are the same, and FIG. 2(b) is a conceptual diagram of power transfer between the power supply sections in a case where the connection circuit 108 is not provided.

FIG. 3(a) is a diagram illustrating a specific configuration example (capacitor) of the connection circuit according to Embodiment 1 of the present invention, FIG. 3(b) is a diagram illustrating a specific configuration example (inductor) of the connection circuit according to Embodiment 1 of the present invention, FIG. 3(c) is a diagram illustrating a specific configuration example (parallel resonance circuit) of the connection circuit according to Embodiment 1 of the present invention, FIG. 3(d) is a diagram illustrating a specific configuration example (serial resonance circuit) of the connection circuit according to Embodiment 1 of the present invention, and FIG. 3(e) is a diagram illustrating a specific configuration example (meander pattern) of the connection circuit according to Embodiment 1 of the present invention.

FIGS. 4(a) and 4(b) are diagrams illustrating a characteristic analysis model of the portable wireless terminal according to Embodiment 1 of the present invention.

FIG. 5(a) is a characteristic diagram of the S parameter (S11) of the portable wireless terminal according to Embodiment 1 of the present invention, FIG. 5(b) is a characteristic diagram of the S parameter (S22) of the portable wireless terminal according to Embodiment 1 of the present invention, and FIG. 5(c) is a characteristic diagram of the S parameter (S21) of the portable wireless terminal according to Embodiment 1 of the present invention.

FIG. 6(a) is a diagram illustrating a graph of a relationship between the antenna efficiency and the difference between the widths of the elements on a condition that the sum of the length 110 of the short side and the length 109 of the short side is 4 mm, and FIG. 6(b) is a diagram illustrating a graph of a relationship between the antenna efficiency and the difference between the widths of the elements on a condition that the sum of the length 110 of the short side and the length 109 of the short side is 8 mm.

FIG. 7 is a diagram illustrating a graph of a convergence time of the electric power in a first power supply section, on the condition that the sum of the length 110 of the short side and the length 109 of the short side is 4 mm, in Embodiment 1 of the present invention.

FIG. 8(a) is a diagram illustrating a graph of a relationship between the antenna efficiency and the difference of the widths of the elements±the sum of the widths of the elements, on the condition that the sum of the length 110 of the short side and the length 109 of the short side is 4 mm, in Embodiment 1 of the present invention, and FIG. 8(b) is a diagram illustrating a graph of a relationship between the antenna efficiency and the difference of the widths of the elements÷the sum of the widths of the elements, on the condition that the sum of the length 110 of the short side and the length 109 of the short side is 8 mm, in Embodiment 1 of the present invention.

FIGS. 9(a) and 9(b) are diagrams illustrating a characteristic analysis model of the portable wireless terminal in a case where the connection circuit is not used.

FIG. 10 is a diagram illustrating a graph of a relationship between the antenna efficiency and the widths of the elements, on the condition that the sum of the length 110 of the short side and the length 109 of the short side is 4 mm, in the case where the connection circuit is not used.

FIG. 11 is a configuration diagram of a portable wireless terminal according to Embodiment 2 of the present invention.

FIG. 12 is a configuration diagram of a portable wireless terminal according to Embodiment 3 of the present invention.

FIGS. 13(a) and 13(b) are configuration diagrams of a portable wireless terminal according to Embodiment 4 of the present invention.

FIG. 14 is a configuration diagram of the existing loosely coupled array antenna.

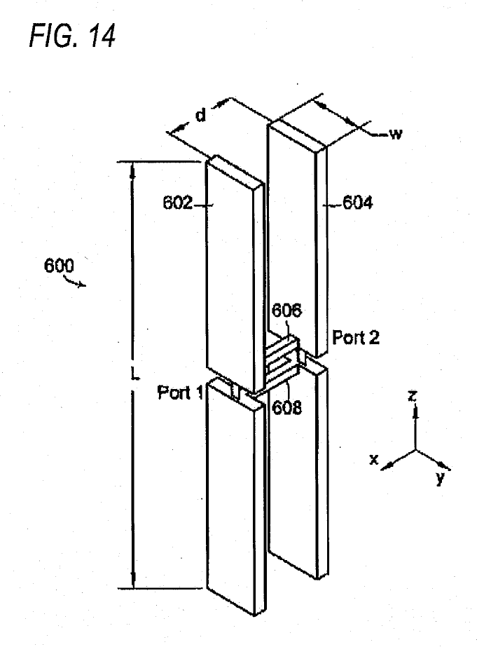

### DESCRIPTION OF EMBODIMENTS

Hereinafter, embodiments of the present invention will be described with reference to drawings.

### Embodiment 1

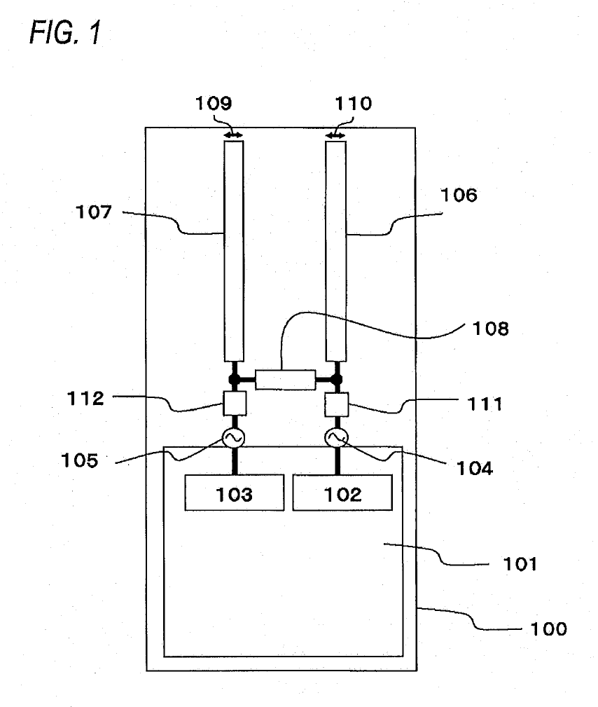

FIG. 1 is a configuration diagram of a portable wireless terminal according to Embodiment 1 of the present invention.

As shown in FIG. 1, a circuit board 101 disposed in the portable wireless terminal 100 includes a first wireless circuit section 102. Thus, a first antenna element 106, which is made of a conductive metal and is substantially rectangular, is supplied with a high-frequency signal through a first power supply section 104. Furthermore, the circuit board 101 includes a second wireless circuit section 103. Thus, a second antenna element 107, which is made of a conductive metal and is substantially rectangular, is supplied with a high-frequency signal through a second power supply section 105.

Both the first wireless circuit section 102 and the second wireless circuit section 103 are used in a wireless system operating at a first frequency.

In FIG. 1, both the first antenna element 106 and the second antenna element 107 are disposed in the portable terminal, and thus have small sizes, where the lengths of the long sides thereof are less than or equal to 0.5 wavelengths in the first frequency band. Further, since it is necessary to build the first antenna element 106 and the second antenna element 107 in a limited inner room of the terminal, the first antenna element and the second antenna element are disposed substantially in parallel so as to be close, and the minimum distance between the closest sides of both antenna elements is less than or equal to 0.5 wavelengths.

The parallel portions of the first antenna element 106 and the second antenna element 107 are disposed substantially in parallel at a distance of 0.5 wavelengths or less. Hence, the high-frequency current, which flows in one antenna element due to the mutual coupling between the antenna elements, flows as induced current in the other antenna element. For this reason, in the supplied current, the induced current, which flows into the other feeding point, is consumed in the resistance component of the characteristic impedance thereof, thereby causing power loss. As a result, the antenna efficiency of the entire antenna deteriorates. Accordingly, there has been used means for improving the antenna efficiency by making the coupling loose in a way that inserts the connection circuit 108 such that it interconnects the end portions of the first antenna element 106 and the second antenna element 107 and adjusts the mutual coupling between the first power supply section and the second power supply section in the first frequency band such that it is less than or equal to −5 dB.

Further, the length 110 of the short side of the first antenna element and the length 109 of the short side of the second antenna element are set to be different, thereby further ameliorating coupling degradation.

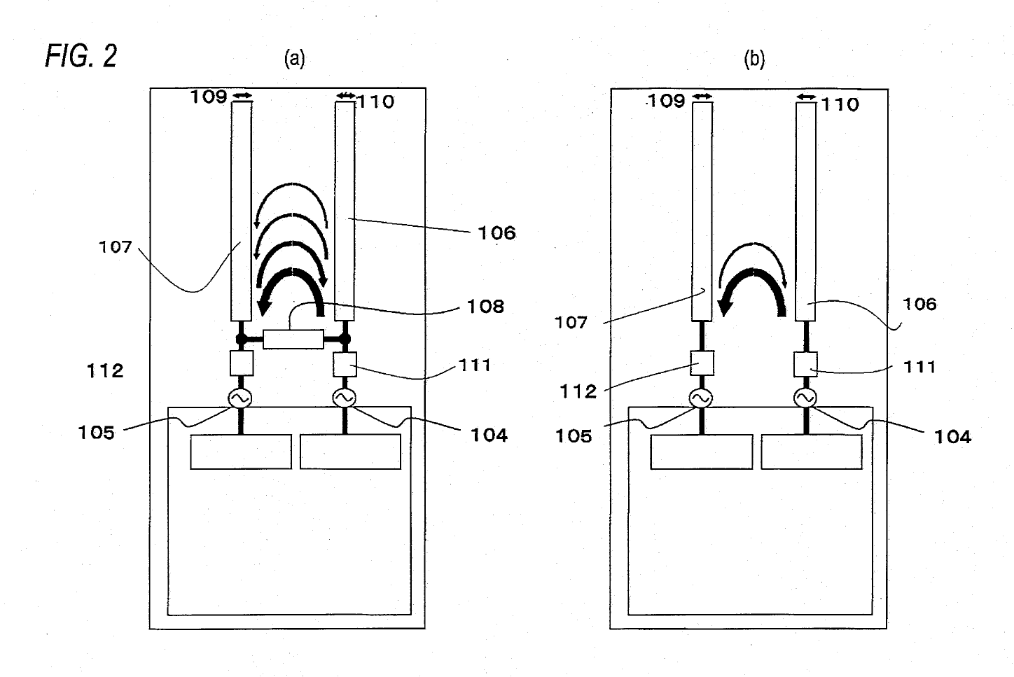

FIG. 2(a) is a conceptual diagram of power transfer between the power supply sections in a case where the length 110 of the short side of the first antenna element and the length 109 of the short side of the second antenna element are the same, and FIG. 2(b) is a conceptual diagram of power transfer between the power supply sections in a case where the connection circuit 108 is not provided. FIG. 2(a) shows a condition in which the connection circuit 108 is used such that the mutual coupling is adjusted to be less than or equal to −5 dB. FIG. 2(b) shows a condition in which the amount of coupling is larger than that of FIG. 2(a).

In this case, although the coupling is made to be loose in FIG. 2(a), the electric power consumed by the resistance components of the characteristic impedances of the power supply sections is reduced. Hence, electric power is accumulated in the first antenna element 106 and the second antenna element 107, the current flowing in the elements resides for a long period of time, and the electric power exchanged between the elements, that is, a sort of resonance phenomenon occurs between both elements. As a result, conductor loss is caused by the exchange of the electric power.

In FIG. 2(b), since the coupling is strong, the electric power consumed by the resistance components of the characteristic impedances of the power supply sections is large, and electric power staying in the elements is small, and the stay time is short. Meanwhile, power loss of the power supply section which does not supply electric power is large, and thus the radiation efficiency of the entire antenna drastically deteriorates.

Accordingly, the length 110 of the short side of the first antenna element and the length 109 of the short side of the second antenna element are set to predetermined lengths which are different, thereby reducing the electric power accumulated in the first antenna element 106 and the second antenna element 107. The reason is that, when the elements having the same shape are made to be close, the current of one element tends to be induced in the other element, but the widths of the elements are slightly different, and thus the induced current is reduced and the electric power accumulated between the elements as the result thereof is reduced. In such a manner, the current exchanged between the elements is reduced, and the conductor loss caused by the elements is reduced. Therefore, the electric power is emitted from both elements into space in a shorter period of time, and this leads to improvement in the antenna efficiency.

Furthermore, the first antenna element 106 is connected to the first power supply section 104 through a first impedance matching circuit 111, and the second antenna element 107 is connected to the second power supply section 105 through a second impedance matching circuit 112. By arranging the first impedance matching circuit 111 and the second impedance matching circuit 112, it is possible to further minutely adjust the impedance matching of the first antenna element 106, the impedance matching of the second antenna element 107, and the mutual coupling between the antenna elements. Thus, it is possible to achieve an antenna with further high efficiency.

Further, by making the coupling loose, independence of the first impedance matching circuit 111 and the second impedance matching circuit 112 is improved. That is, it is possible to individually design the first impedance matching circuit 111 and the second impedance matching circuit 112, and it is easy to adjust the matching circuit. For example, even when the constant numbers and the matching circuit configuration of the first impedance matching circuit 111 are changed, the constant numbers and the optimum matching circuit configuration of the second impedance matching circuit 112 are not changed. Hence, even when the first impedance matching circuit 111 is changed, it is not necessary to change the second impedance matching circuit 112 again.

It should be noted that, in the configuration of FIG. 1, although the first antenna element 106 and the second antenna element 107 are described as substantially rectangular conductive metal components, the elements may be formed as copper foil patterns formed on the printed-circuit board. Even in this case, it is possible to obtain the same effect.

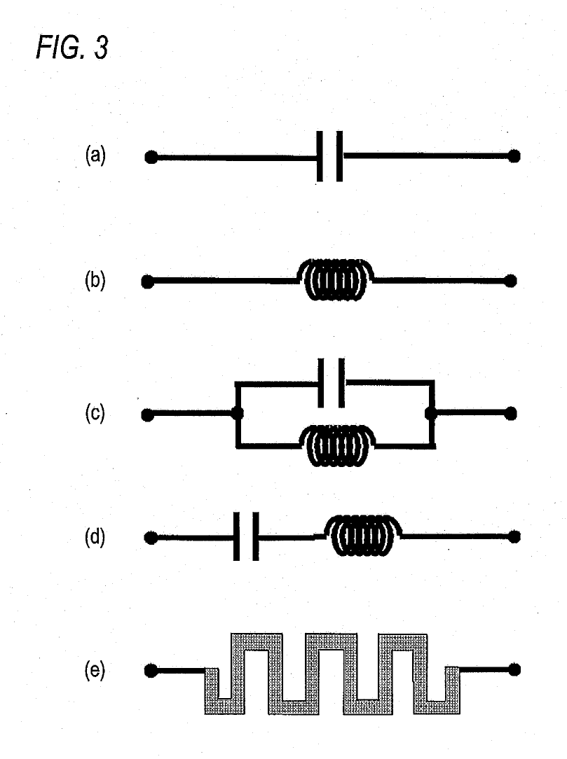

FIG. 3 is a diagram illustrating specific configurations of connection circuits according to Embodiment 1 of the present invention. As shown in FIG. 3, possible connection circuits include (a) a capacitor, (b) an inductor, (c) a parallel resonance circuit, (d) a serial resonance circuit, and (e) a configuration of a meander pattern. Further, in other configurations, any configuration may be adopted as well if the configuration is a configuration in which an equivalent circuit such as a filter or a capacitor formed as a pattern can be represented by combination of capacitors or inductors and the mutual coupling impedance can be adjusted. Furthermore, it may be possible to adopt a configuration in which a plurality of the configurations are combined.

Subsequently, a description will be given of an example in which the antenna characteristics of the specific configuration of FIG. 1 are analyzed.

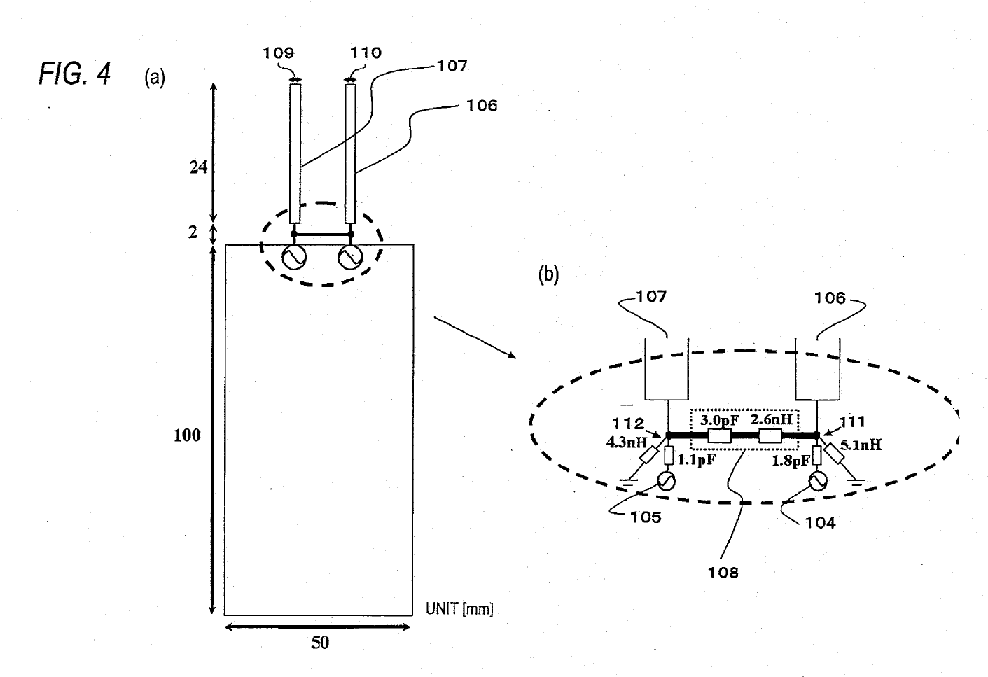

FIG. 4 is a diagram illustrating a characteristic analysis model of the portable wireless terminal according to Embodiment 1 of the present invention. As shown in FIG. 4(a), the circuit board 101 is formed as a printed-circuit board made of glass epoxy. However, the circuit board is modeled to be formed of a copper foil with a length of 100 mm and a width of 50 mm, and is analyzed. In the circuit board 101, the first antenna element 106 and the second antenna element 107 formed of conductive copper patterns are supplied with the high-frequency signal through the first power supply section 104 and the second power supply section 105. The high-frequency signals of 1 GHz to 3 GHz including the first frequency band of 2 GHz are supplied from the first power supply section 104 and the second power supply section 105, and analysis is performed on the coefficient of the pass characteristic S parameter S21, the reflection characteristic S parameter S11, and S parameter S22, which are the S parameters, and the antenna efficiency.

The first antenna element 106 is set to have a length of 24 mm, while the second antenna element 107 is set to have a length of 24 mm.

The first antenna element 106 and the second antenna element 107 are disposed in parallel at a distance of 2 mm from the ground pattern. The antenna length of 26 mm including the connection line length of 2 mm from the power supply section is equivalent to a length of 0.173 wavelengths when the wavelength at 2 GHz is 150 mm. The shortest distance between the closest sides of the first antenna element 106 and the second antenna element 107 in the inner sides of the substantially parallel portions of both antenna elements is 6 mm, and is a distance extremely approximate to 0.04 wavelengths at 2 GHz.

The first antenna element 106 and the second antenna element 107 are disposed substantially in parallel at an electrically close distance. Hence, the high-frequency current, which flows in one antenna element due to the mutual coupling between the antenna elements, flows as induced current in the other antenna element. Accordingly, the coupling between the power supply sections becomes strong, and thus the electric power reaching the feeding point opposed to that of the power supply section is consumed in the resistance component of the characteristic impedance thereof. As a result, the antenna efficiency deteriorates. Therefore, the mutual coupling between the first power supply section and the second power supply section in the first frequency band is adjusted through the connection circuit 108 shown in FIG. 4(b) so as to be less than or equal to −5 dB, thereby making the coupling loose. As a result, the antenna efficiency is improved.

Further, the sum of the length 110 of the short side of the first antenna element 106 and the length 109 of the short side of the second antenna element 107 is 8 mm, and the length 110 of the short side of the first antenna element, the length 109 of the short side of the second antenna element are set to predetermined lengths which are different. For example, in the configuration of FIG. 4, the length 110 of the short side of the first antenna element is 1.85 mm, the length 109 of the short side of the second antenna element is 2.15 mm, and the difference therebetween is 0.3 mm. With this configuration, the electric power is not accumulated in the first antenna element and the second antenna element, the electric power is emitted to space at an earlier time from both the first antenna element 106 and the second antenna element 107, thereby reducing the electric power exchanged between the antenna elements disposed to be close and reducing the conductor loss caused by the elements. As a result, the radiation efficiency of the entire antenna is improved.

As shown in FIG. 4(b), the connection circuit 108 is formed of a connection line of approximately 6 mm, and a capacitor of 3.0 pF and an inductor of 2.6 nH are arranged in series at the center thereof. Furthermore, the first impedance matching circuit 111 has 1.8 pF which is set on the first power supply section 104 side, and is grounded by 5.1 nH of the ground pattern of the circuit board. The second impedance matching circuit 112 has 1.1 pF which is set on the second power supply section 105 side, and is grounded by 4.3 nH of the ground pattern of the circuit board. Since the first antenna element 106 and the second antenna element 107 are asymmetric, the first impedance matching circuit 111 and the second impedance matching circuit 112 are generally asymmetric constant numbers as well.

In addition, by disposing the first impedance matching circuit 111 and the second impedance matching circuit 112 at the origins of the respective antenna elements, it is possible to further minutely adjust the impedance matching of the first antenna element 106, the impedance matching of the second antenna element 107, and the mutual coupling between the antenna elements. Thus, the effect that reduces coupling degradation further increases.

Further, by making the coupling loose, independence of the first impedance matching circuit 111 and the second impedance matching circuit 112 is improved. That is, it is possible to individually design the first impedance matching circuit 111 and the second impedance matching circuit 112, and it is easy to adjust the matching circuit. For example, even when the constant numbers and the matching circuit configuration of the first impedance matching circuit 111 are changed, the constant numbers and the optimum matching circuit configuration of the second impedance matching circuit 112 are not changed. Hence, even when the first impedance matching circuit 111 is changed, there is no necessity to change the second impedance matching circuit 112 again.

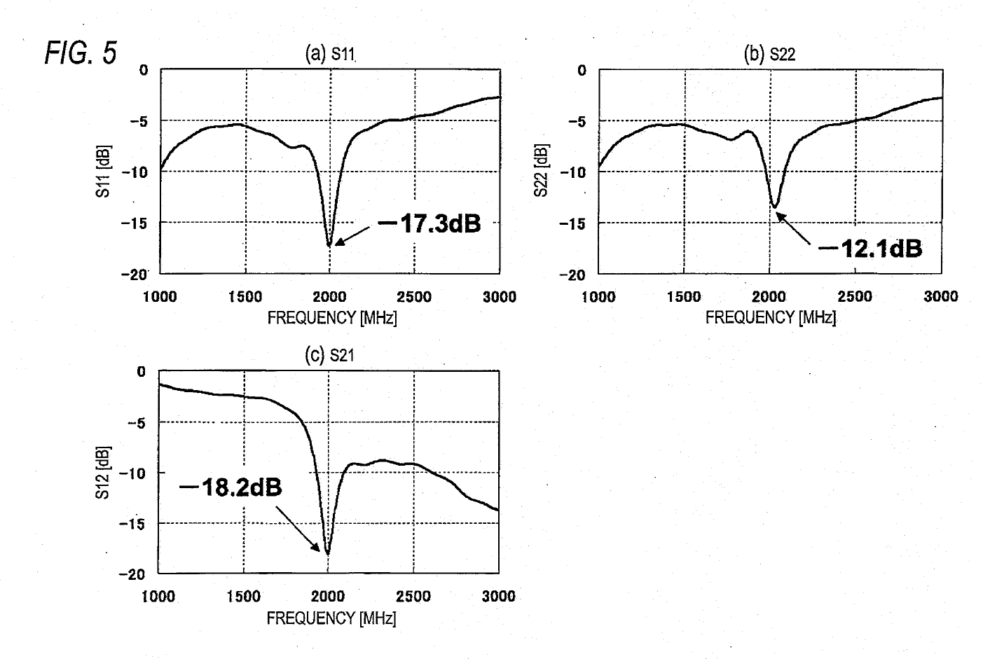

FIG. 5 is an S parameter characteristic diagram, which is analyzed by using the analysis model of FIG. 4, according to Embodiment 1 of the present invention. FIG. 5(a) shows the S11 waveform viewed from the first power supply section 104. FIG. 5(b) shows the S22 waveform viewed from the second power supply section 105. Further, FIG. 5(c) shows the S21 waveform which is pass characteristics from the first power supply section 104 to the second power supply section 105. In each diagram, the horizontal axis indicates the characteristics of the frequency range from 1 GHz to 3 GHz.

As shown in FIG. 5(a), the S parameter S11 at 2 GHz is a low value less than or equal to −10 dB, and thus it can be observed that the impedances are matched in this frequency band. Further, as shown in FIG. 5(b), the S parameter S22 at 2 GHz is a low value less than or equal to −10 dB as well, and thus it can be observed that the impedances are matched in this frequency band. Furthermore, as shown in FIG. 5(c), S21 which is the pass characteristics at 2 GHz is a low value less than or equal to −10 dB, and thus it can be observed that isolation is ensured in this frequency band and the amount of coupling is reduced. As described above, at 2 GHz, the impedance matching and isolation are ensured. As a result, it can be observed that an adjustment is performed such that coupling degradation is reduced.

Next, a description will be given of the antenna efficiency in combination between the length 110 of the short side of the first antenna element 106 and the length 109 of the short side of the second antenna element 107 where the sum of the length 110 of the short side of the first antenna element 106 and the length 109 of the short side of the second antenna element 107 is designed to have two values of 4 mm and 8 mm.

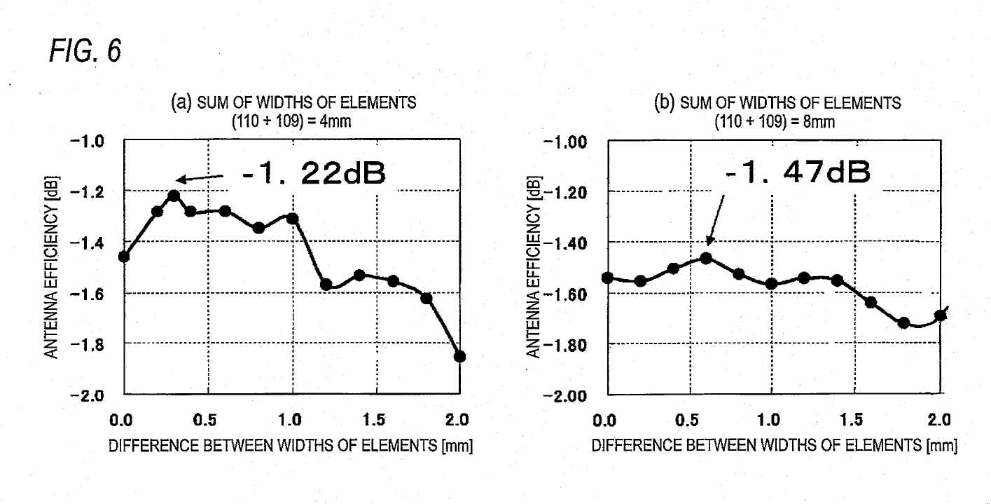

FIG. 6(a) shows the antenna efficiency based on the length 110 of the short side of the first antenna element 106 and the length 109 of the short side of the second antenna element 107, on a condition that the sum of the length 110 of the short side and the length 109 of the short side is 4 mm, in Embodiment 1 of the present invention. FIG. 6(b) shows the antenna efficiency in a case where the length 110 of the short side of the first antenna element 106 and the length 109 of the short side of the second antenna element 107 are changed on a condition that the sum of the length 110 of the short side and the length 109 of the short side is 8 mm, in Embodiment 1 of the present invention. The vertical axis indicates the sum of the antenna efficiencies of the antennas in units of [dB] in a case where the first power supply section 104 and the second power supply section 105 respectively supplies electric power. The horizontal axis indicates the difference between the length 110 of the short side and the length 109 of the short side in units of [mm].

It can be seen from FIGS. 6(a) and 6(b) that there is a difference between the length 110 of the short side and the length 109 of the short side by which the maximum antenna efficiency is obtained.

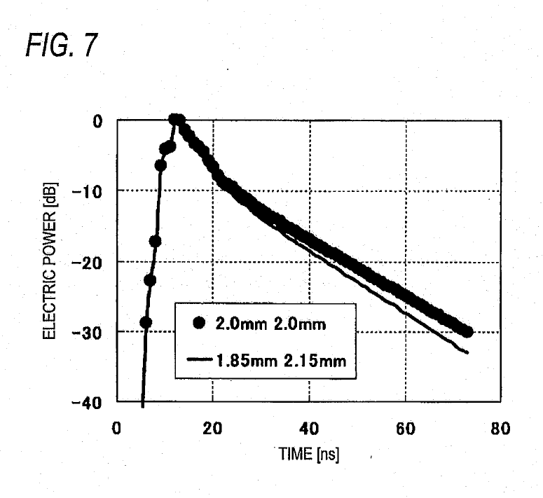

FIG. 7 shows an analysis result representing the convergence time of electric power in the power supply sections with two models of a case where each of the length 110 of the short side and the length 109 of the short side is 2 mm and a case where the length 109 of the short side is 1.85 mm and the length 109 of the short side is 2.15 mm by which the maximum antenna efficiency is obtained in FIG. 6(a). The vertical axis indicates that the maximum value of the electric power of the first power supply section 105 is normalized to 0 dB, and the horizontal axis indicates the passage of time. It can be seen from FIG. 7 that to change the length 110 of the short side and the length 109 of the short side causes the electric power to converge during a shorter period of time and the emitted electric power increase to that extent. That is, it can be seen that, by selecting the lengths of the short sides of the elements having different values, the antenna efficiency is improved. The reason is that, when the elements having the same shape are made to be close, the current of one element tends to be induced in the other element, but the widths of the elements are slightly different, and thus the induced current exchanged between the first antenna element and the second antenna element is reduced, the conductor loss caused by the elements is reduced, and the electric power accumulated between the elements as the result thereof is reduced. Thereby, the radiation efficiency of the entire antenna is improved.

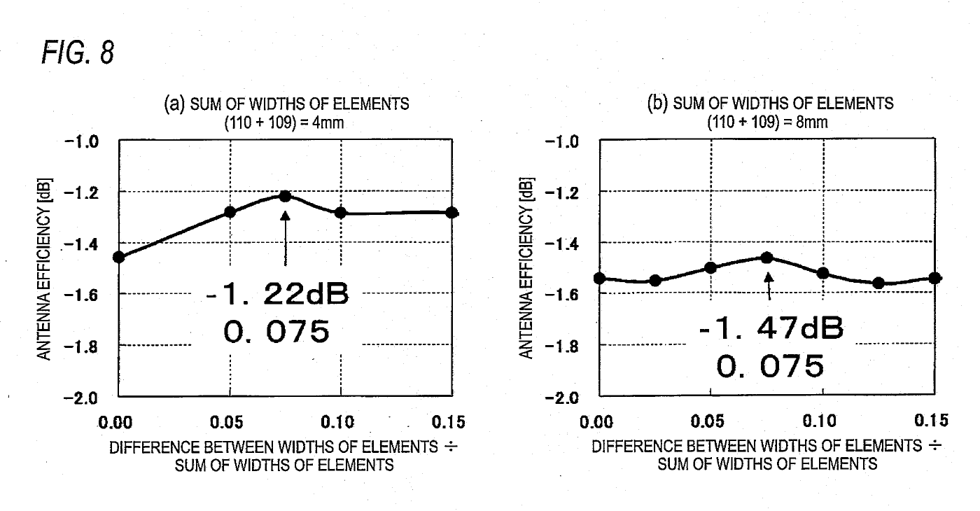

In FIG. 8, the vertical axis is the same as the vertical axis of FIG. 6, and the horizontal axis is changed to indicate a value which is obtained by dividing the difference between the length 110 of the short side and the length 109 of the short side by the sum of the length 110 of the short side and the length 109 of the short side. FIGS. 8(a) and 8(b) are similar to FIGS. 6(a) and 6(b), where (a) shows the case where the sum of the length 110 of the short side and the length 109 of the short side is 4 mm and (b) shows the case where the sum of the length 110 of the short side and the length 109 of the short side is 8 mm.

It can be seen from FIG. 8 that, in the relationship between the length 110 of the short side and the length 109 of the short side, regardless of the sum of the length 110 of the short side and the length 109 of the short side, the antenna efficiency is highest when the value obtained by dividing the difference between the length 110 of the short side and the length 109 of the short side by the sum of the length 110 of the short side and the length 109 of the short side is 0.075, and high antenna efficiency is obtained when the value is less than or equal to 0.1.

That is, it can be seen that, when the following Expression 1 is satisfied, it is possible to obtain high antenna efficiency.

0<|the length 110 of the short side of the first antenna element 106−the length 109 of the short side of the second antenna element 107|+|the length 110 of the short side of the first antenna element 106+the length 109 of the short side of the second antenna element 107|≦0.1

Further, as can be seen from FIG. 8, it is possible to obtain the highest antenna efficiency when the following Expression 2 is satisfied.

|the length 110 of the short side of the first antenna element 106−the length 109 of the short side of the second antenna element 107|±|the length 110 of the short side of the first antenna element 106+the length 109 of the short side of the second antenna element 107| 0.075

As described above, by adopting the present Embodiment 1, in the first frequency band used by operating the first antenna element 106 and the second antenna element 107, it is possible to improve both coupling degradation and conductor loss. Thus, it is possible to design a high-gain built-in array antenna which is loosely coupled.

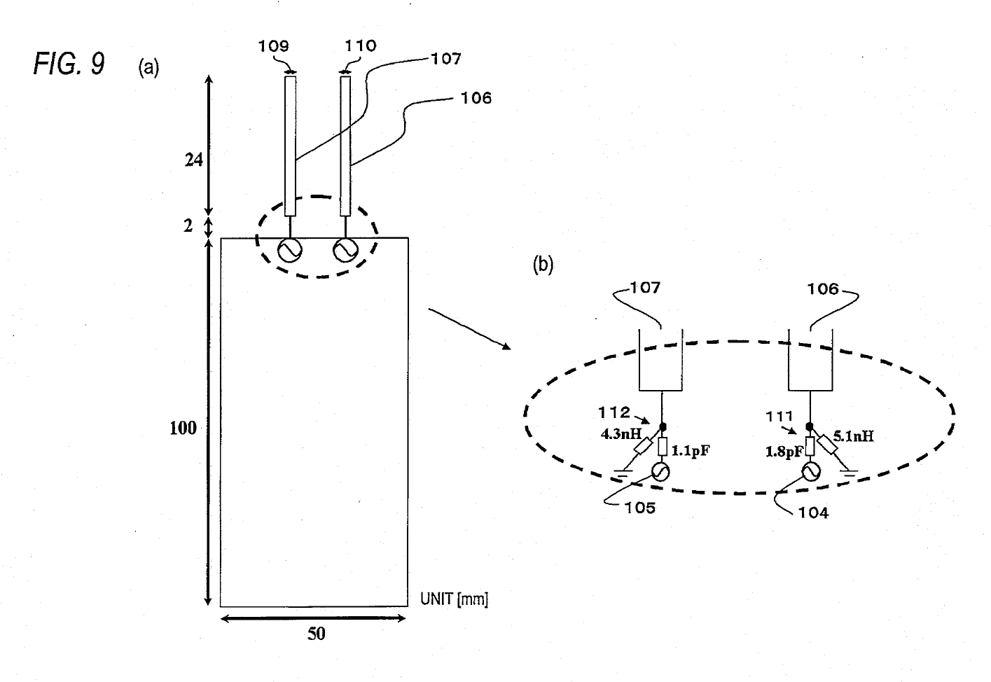

Further, FIG. 9 shows an array antenna analysis model in a case where the connection circuit 108 is not used in FIG. 1, that is, a case where the weak coupling countermeasure is not performed.

As shown in FIG. 9(b), the first impedance matching circuit 111 has 1.8 pF which is set on the first power supply section 104 side, and is grounded by 5.1 nH of the ground pattern of the circuit board. The second impedance matching circuit 112 has 1.1 pF which is set on the second power supply section 105 side, and is grounded by 4.3 nH of the ground pattern of the circuit board. By using the matching circuit, the S parameters S11 and S22 are set to be less than or equal to −10 dB in the first frequency band.

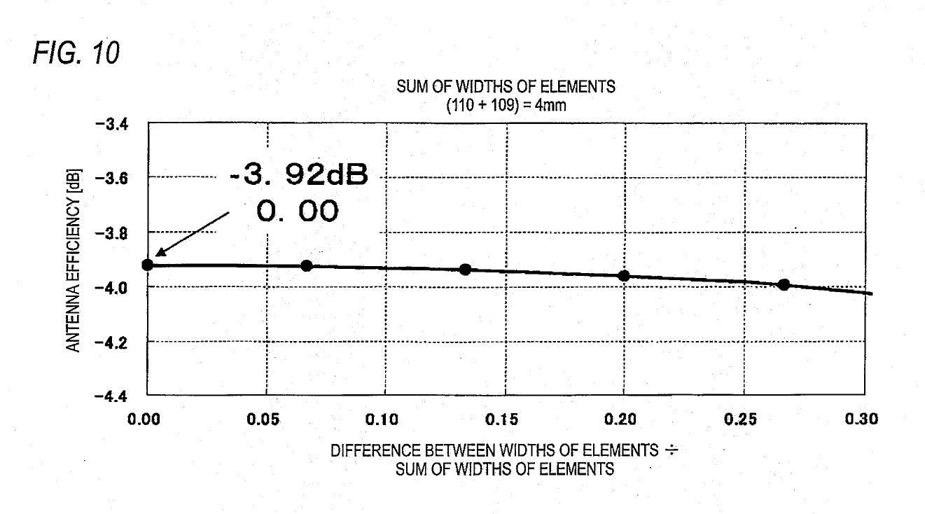

FIG. 10 shows the antenna efficiency obtained when the ratio of the length 110 of the short side of the first antenna element and the length 109 of the short side of the second antenna element is changed while the sum of the length 110 of the short side of the first antenna element and the length 109 of the short side of the second antenna element is maintained at 4 mm, in the case where the connection circuit is not used.

The vertical axis indicates the sum of the antenna efficiencies of the antennas in units of [dB] in a case where the first power supply section 104 and the second power supply section 105 respectively supply electric power. The horizontal axis is changed to indicate the value which is obtained by dividing the difference between the length 110 of the short side and the length 109 of the short side by the sum of the length 110 of the short side and the length 109 of the short side when the difference between the length 110 of the short side and the length 109 of the short side is expressed in units of [mm]. FIG. 10 shows, similarly to FIG. 6(a), the case where the sum of the length 110 of the short side and the length 109 of the short side is 4 mm.

Compared with the result of FIG. 8, in the result of FIG. 10, it can be observed that the radiation efficiency is lowered by 2 dB or more, and thus it can be seen that coupling degradation occurs when the connection circuit is not used. Furthermore, in FIG. 10, the connection circuit is not used, that is, the weak coupling countermeasure is not performed. In this case, it can be observed that, if the difference between the length 110 of the short side and the length 109 of the short side is 0, that is, if the widths of the antenna elements are the same, it is possible to obtain the maximum antenna efficiency. That is, it can be observed that the countermeasure for improving the antenna efficiency by setting a predetermined difference between the length 110 of the short side and the length 109 of the short side is effective when the connection circuit is used as the weak coupling countermeasure.

It should be noted that, in the above-mentioned embodiments, the first antenna element and the second antenna element are configured to be parallel with the ground pattern of the circuit board 101 provided in the portable wireless terminal 100 constituting the casing, and the first antenna element and the second antenna element are configured to be parallel with each other, but the ground pattern may be configured to not be provided on the circuit board 101, and may be configured such that the impedances thereof are matched in the entire circuit.

### Embodiment 2

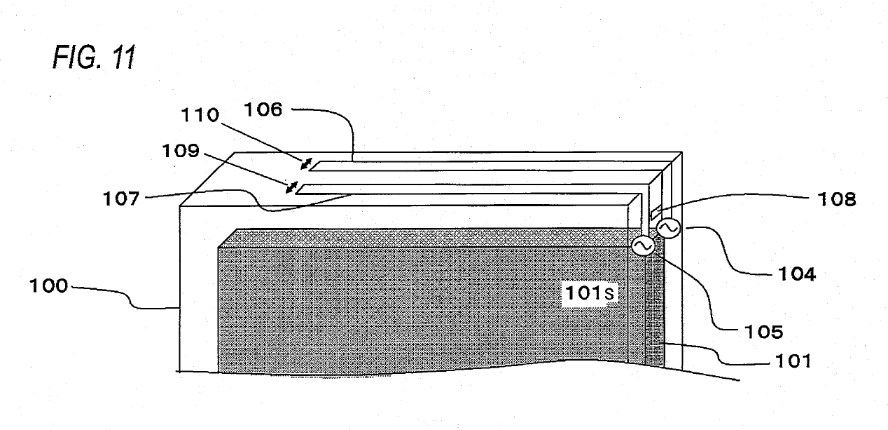

FIG. 11 is a configuration diagram of a portable wireless terminal according to Embodiment 2 of the present invention. In FIG. 11, the components common to FIG. 1 will be referenced by the same reference numerals and signs, and description thereof will be omitted.

In FIG. 11, the first antenna element 106 and the second antenna element 107 are stretched to be substantially perpendicular to the circuit board 101, and are then disposed to be bent at a right angle along the inner wall of the casing of the portable wireless terminal 100.

Further, the length 110 of the short side of the first antenna element and the length 109 of the short side of the second antenna element are set to be different lengths as defined by Expression 1 or Expression 2 mentioned above.

By arranging the elements as described above, it is possible to house the antenna elements in the casing of the portable wireless terminal 100 with a small occupied volume of the end portion of the casing. As a result, it is possible to achieve the loosely coupled antenna characteristics while reducing the size of the device.

### Embodiment 3

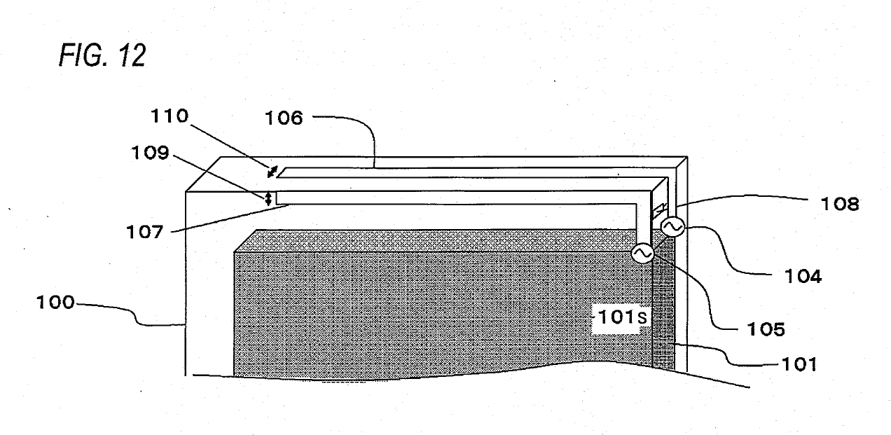

FIG. 12 is a configuration diagram of a portable wireless terminal according to Embodiment 3 of the present invention.

In FIG. 12, the components common to FIG. 1 will be referenced by the same reference numerals and signs, and description thereof will be omitted.

In FIG. 12, the first antenna element 106 and the second antenna element 107 are stretched substantially perpendicular to a principal surface 101S of the circuit board 101 such that the inner wall of the casing of the portable wireless terminal 100 faces another surface, and are then disposed to be bent at a substantially right angle along the inner wall of the casing of the portable wireless terminal 100. In addition, the length 110 of the short side of the first antenna element 106 and the length 109 of the short side of the second antenna element 107 are set to be different lengths as defined by Expression 1 or Expression 2 mentioned above. The first antenna element 106 and the second antenna element 107 are disposed in parallel with each other at a predetermined distance. In addition, the first antenna element 106 and the second antenna element 107 are connected through the connection circuit 108 made of a copper foil pattern in the vicinity of the first power supply section 104 and the second power supply section 105.

By arranging the elements as described above, it is possible to house the antenna elements in the casing of the portable wireless terminal 100 with a small occupied volume of the end portion of the casing. As a result, it is possible to achieve the loosely coupled antenna characteristics while reducing the size of the device.

### Embodiment 4

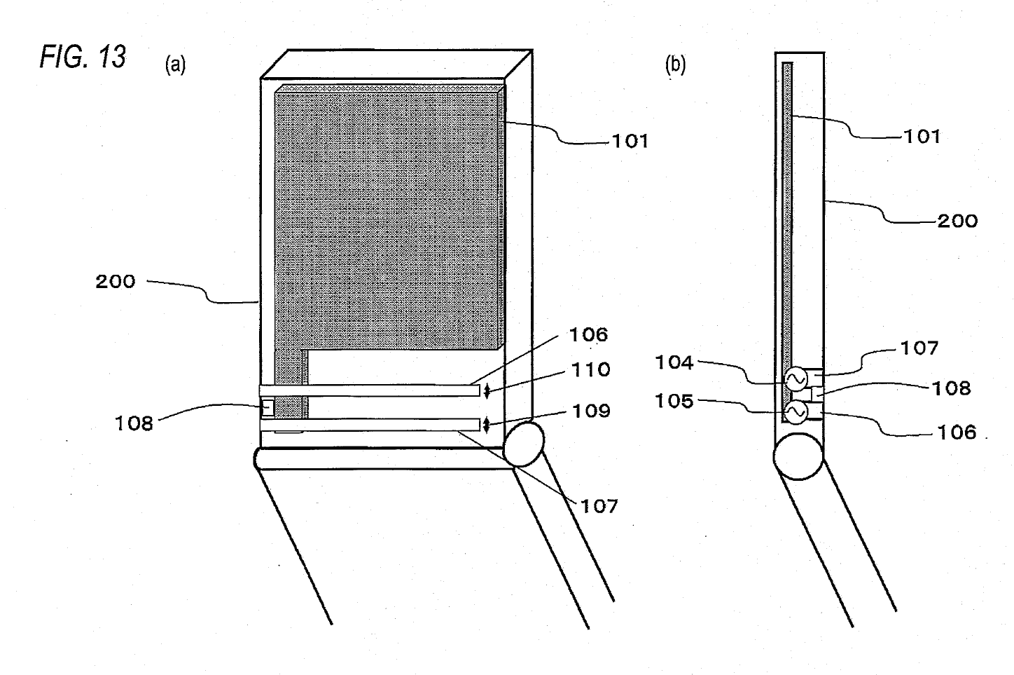

FIG. 13 is a configuration diagram of a portable wireless terminal according to Embodiment 4 of the present invention.

In FIG. 13, the components common to FIG. 1 will be referenced by the same reference numerals and signs, and description thereof will be omitted.

FIG. 13(a) is a diagram of a folder-type portable wireless terminal 200 viewed from the back. Further, FIG. 13(b) is a cross-sectional view of the folder-type portable wireless terminal 200. In FIG. 13, the first antenna element 106 and the second antenna element 107 are stretched to be substantially perpendicular to a principal surface 101S of the circuit board 101, and are then disposed to be bent at a right angle along the inner wall of the casing of the folder-type portable wireless terminal 200. The second antenna element 107 is disposed to be bent at a substantially right angle along the inner wall of the casing of the folder-type portable wireless terminal 200 of which the leading end portion can be folded. In addition, the length 110 of the short side of the first antenna element 106 and the length 109 of the short side of the second antenna element 107 are set to be different lengths as defined by Expression 1 or Expression 2 mentioned above. The first antenna element 106 and the second antenna element 107 are disposed on two perpendicular surfaces of the casing 100 and are disposed in parallel with each other at a predetermined distance, at the leading end portion. In addition, the first antenna element 106 and the second antenna element 107 are connected through the connection circuit 108 made of a copper foil pattern in the vicinity of the first power supply section 104 and the second power supply section 105.

By arranging the elements as described above, it is possible to house the antenna elements in the casing of the folder-type portable wireless terminal 200 with a small occupied volume of the back side of the casing. Thus, it is possible to achieve the loosely coupled antenna characteristics while reducing the size of the device. As a result, there is the effect capable of ensuring excellent antenna characteristics.

It should be noted that, in the embodiments, an example in which two antenna elements are disposed to be close is described, but in a case of three or more antenna elements, two antenna elements, which are disposed to be adjacent and connected in the vicinity of the power supply sections, are also formed to have different widths (short sides), whereby it is possible to provide a high-efficiency array antenna.

This application is based on Japanese Patent Application No. 2010-110742 filed on the 13th of May in 2010, which is incorporated herein by reference.

### INDUSTRIAL APPLICABILITY

The antenna device of the present invention and the portable wireless terminal equipped with the same are able to achieve a high-efficiency loosely coupled array antenna operating at an arbitrary frequency, and are thus useful for the portable wireless terminals such as a MIMO mobile phone.

### REFERENCE SIGNS LIST

100 PORTABLE WIRELESS TERMINAL
101 CIRCUIT BOARD
102 FIRST WIRELESS CIRCUIT SECTION
103 SECOND WIRELESS CIRCUIT SECTION
104 FIRST POWER SUPPLY SECTION
105 SECOND POWER SUPPLY SECTION
106 FIRST ANTENNA ELEMENT
107 SECOND ANTENNA ELEMENT
108 CONNECTION CIRCUIT
109 LENGTH OF SHORT SIDE OF SECOND ANTENNA ELEMENT
110 LENGTH OF SHORT SIDE OF FIRST ANTENNA ELEMENT
111 FIRST IMPEDANCE MATCHING CIRCUIT
112 SECOND IMPEDANCE MATCHING CIRCUIT
200 FOLDER-TYPE PORTABLE WIRELESS TERMINAL

1. An antenna device comprising:
a circuit board;
a first antenna element that is made of a conductive metal and that is substantially rectangular;
a second antenna element that is made of a conductive metal and is substantially rectangular; and
a connection circuit that electrically interconnects the first antenna element and the second antenna element;
wherein the first antenna element and the second antenna element are electrically connected to a first power supply section and a second power supply section which are disposed in parallel with each other on an end of the circuit board; and
wherein a length of a short side of the first antenna element and a length of a short side of the second antenna element are adjusted so as to have a difference which does not cause resonance phenomenon in electric power between the first antenna element and the second antenna element.

2. The antenna device according to claim 1, wherein:
the circuit board has a ground pattern;
the first antenna element and the second antenna element are disposed to be close to each other substantially in parallel at a predetermined distance away from the ground pattern on the circuit board;
the length of the short side of the first antenna element and the length of the short side of the second antenna element satisfy that (|the length of the short side of the first antenna element−the length of the short side of the second antenna element|)+(the length of the short side of the first antenna element+the length of the short side of the second antenna element) is less than or equal to approximately 0.1 and is greater than 0; and
the connection circuit is adjusted such that mutual coupling between the first antenna element and the second antenna element in a first frequency band is canceled.

3. The antenna device according to claim 2, wherein the distance between closest sides of the first antenna element and the second antenna element is less than or equal to 0.5 wavelengths in the first frequency band.

4. The antenna device according to claim 2, wherein a length of each long side of the first antenna element and the second antenna element is less than or equal to 0.5 wavelengths in the first frequency band.

5. The antenna device according to claim 2, wherein the first antenna element is electrically connected to the first power supply section through a first impedance matching circuit, and the second antenna element is electrically connected to the second power supply section through a second impedance matching circuit.

6. The antenna device according to claim 2, further comprising:
a casing;
wherein the first antenna element and the second antenna element are disposed to be substantially orthogonal to a principal surface of the circuit board on a side of the circuit board, are bent along an inner wall of the casing, and are disposed in the casing.

7. The antenna device according to claim 2, wherein either one or both of the first antenna element and the second antenna element is formed as a copper foil pattern on a printed-circuit board.

8. A portable wireless terminal comprising the antenna device according to claim 1.

9. A MIMO-capable portable wireless terminal comprising the antenna device according to claim 1.
